(19) United States
(12) Patent Application Publication
(10) Pub. No.: US 2009/0103312 A1
(43) Pub. Date: Apr. 23, 2009

(54) Light Emitting Plate

(76) Inventor: Chester R. Batson, Whittier, CA (US)

Correspondence Address: ADVANTIA LAW GROUP, 9035 SOUTH 1300 EAST, SUITE 200, SANDY, UT, 84094, US

(21) Appl. No.: 11/876,393

(22) Filed: Oct. 22, 2007

(51) Int. Cl. F21S 10/00; F21S 13/14

(52) U.S. Cl. 362/311.13

(57) ABSTRACT

A light emitting plate. The plate includes a circular planar member, a plurality of light emitting devices, a control module, a light sensor module, a power module, and a decorative layer. The cylindrical planar member is cylindrical in shape with a cylindrical cavity having a low aspect ratio through its top surface. The light emitting devices are visible through the top surface of the circular planar member. The control module controls an activation status of the light emitting devices. The light sensor module provides a signal to the control module, wherein the signal is indicative of a light level. The power module comprises a battery and a power cord and provides power to the light emitting devices. The decorative layer decorates the top surface of the circular planar member.

### BACKGROUND OF THE INVENTION

1. Field of the Invention

The present invention relates to decorative plates, specifically a light emitting plate.

2. Description of the Related Art

Many people employ decorative plates to eat food items thereon, as well as enhance the appearance and décor of the environment surrounding them. However, what is needed is a plate that may be employed to provide a variety of decorative lighted images according to a person's preference and is suitable to decorate a multitude of structures during special occasions or anytime during the year. Improvements have been made in the field. Examples include but are not limited to the references described below, which references are incorporated by reference herein:

U.S. Pat. No. 4,556,932, issued to Lehrer, discloses a battery-powered, self-contained lighted novelty item incorporates a removable face plate. A square, transparent area formed on the center of the face plate is superimposed over a prism shaped lens within the novelty item. An electrical circuit including a light emitting diode is included within the novelty item to illuminate the transparent area on the face plate. A design or figure applied to the face plate, and in particular to the transparent area on the center of the face plate, will be illuminated when the electrical circuit is completed and the light emitting diode is energized.

U.S. Pat. No. 6,065,600, issued to Chen, discloses a plate includes a plate body, a decorative member and a decorative small plate respectively combined on the plate body separably. The decorative member has a base for containing a light emitting device to emit flickering light through holes in its wall. Dry ice may be placed under the decorative member in a recess for the decorative member to fit and stand on the plate body, producing smoke like mist rising up and dispersing through the holes of its wall. Then the plate is placed with food on its upper surface, with light flickering and smoke like mist slowly rising up, enhancing pleasing romantic atmosphere during dining. Further, the decorative small plate may be taken off the plate body for serving a small amount of food, and separable together with the decorative member from the plate body for convenience of storing and packaging.

U.S. Pat. No. 5,137,761, issued to Altmayer, discloses a decorative plaque comprising, in sequence, from the outside to the inside, a semitransparent reflecting plate, a light transmitting glass plate spaced from the semi-transparent reflecting plate having a plurality of faceted glass stones affixed to one side thereof in an ornamental arrangement facing towards the reflective surface of the semi-transparent reflecting plate, and, on the opposite side of the light transmitting glass plate and spaced therefrom, a fully reflective plate. The plaque is arranged so that it is internally illuminated, for example by ambient light. Viewing of the interior of the plaque occurs through the semi-transparent reflecting plate.

U.S. Pat. No. 5,313,724, issued to Warner, discloses a picture frame is formed in a perimeter relationship relative to a central support plate. The picture frame includes a housing coextensively directed about the support plate, with the housing including a housing section associated with each side of the support plate. Each housing section includes an elongate cylindrical illumination bulb mounted therewithin. A transparent lens is positioned contiguous to and adjacent each edge of the central support plate coextensive with each illumination bulb to direct illumination onto the central support plate. A modification of the invention includes each elongate bulb formed with a plurality of semi-cylindrical coatings, including an opaque, translucent, and clear coating to provide a varying degree of illumination directed upon the central support plate.

U.S. Pat. No. 5,412,887, issued to Layne, discloses an illuminated display assembly for a consumer product such as a video tape, compact disc, book, audio tape, and the like. The display assembly having a frame casing with a generally rectangular opening designed to receive the consumer product. The opening is defined by parallel top and bottom interior walls, joined by interior side walls, relating substantially to the corresponding vertical and horizontal dimensions of the consumer product. Within the frame casing is housed one or more light elements which are programmed to illuminate in various fashions to draw the attention of the consumer to the consumer product.

U.S. Design Pat. No. 411,482, issued to Huston, discloses an ornamental design of a golf ball collector plaque.

The inventions heretofore known suffer from a number of disadvantages which include: being limited in applicability; being unable to sense light; being unable to provide a range of light intensities; and/or being unable to automatically emit light under predetermined conditions.

What is needed is a light emitting plate that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available emitting plates and devices. Accordingly, the present invention has been developed to provide a light emitting plate.

There is one embodiment of a light emitting plate that may include: a circular planar member that may be cylindrical in shape and/or may have a low aspect ratio that may have a top surface; a plurality of light emitting devices that may be disposed within the circular planar member and/or may be visible through the top surface; a control module that may be in communication with the plurality of light emitting devices and/or may be configured to control an activation status of the plurality of light emitting devices; and a light sensor module that may be coupled to the circular planar member and/or may be in communication with the control module, wherein the light sensor module provides a signal to the control module, wherein the signal is indicative of a light level;

According to one embodiment of the present invention, the system may also include a power module that may be in communication with the plurality of light emitting devices, and/or may be configured to provide power to the light emitting devices. The power module may comprise a battery and a power cord that may be removably coupleable to an electrical outlet.

In another embodiment of the present invention, there is a decorative layer that may be coupled to the top surface of the circular planar member and/or may be configured to provide a decoration thereon.

In yet another embodiment of the present invention, the circular planar member may include includes a cylindrical cavity that may have a low aspect ratio through the top surface.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a light emitting plate, according to one embodiment of the invention;

FIG. 2 illustrates a side elevational view of a light emitting plate, according to one embodiment of the invention; and

FIG. 3 illustrations a block diagram of a light emitting plate, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

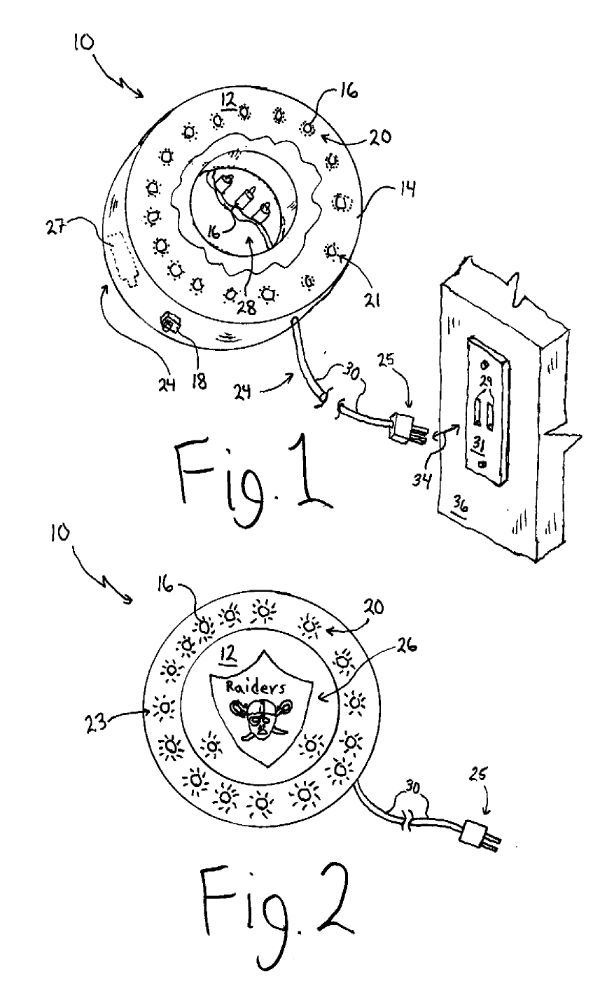

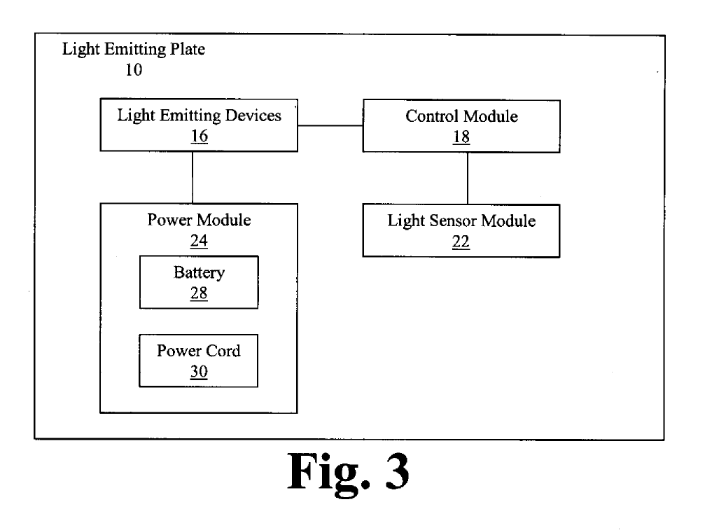

Referring to the drawing figures, there is an embodiment of a light emitting plate 10 that includes: a circular planar member 12 cylindrical in shape and has a low aspect ratio (small depth as compared to width) and a top surface 14; a plurality of light emitting devices 16 disposed within the circular planar member and is visible through the top surface 16; a control module 18 such as SPDT Slide Switch, Rapid Electronics Limited, Severalls Lane, Colchester, Essex C04 5JS United Kingdom, electrically configured to activate the light emitting devices 16 (also referred to as lights) and is configured to control an activation status 20 of the lights 18, wherein the lights are either in a relatively high intensity status 21 as shown in FIG. 1 or a relatively low intensity status 23 as shown in FIG. 2; and a light sensor module 22 such as a PS-2106 PASPORT Light Sensor, PASCO Scientific, Inc., 10101 Foothills Boulevard, Roseville, Calif. 95747, mechanically coupled to the circular planar member 12 and in electrical communication with the control module 18, wherein the light sensor module 22 measures the amount of light that it sees and provides an electromagnetic signal to the control module, wherein the signal is indicative of a light level or intensity, thereby causing the lights 16 to be automatically activated whenever insufficient light is sensed. In other embodiments of the present invention, the activated lights 16 may vary in intensity and color, and either be stationary or blink.

According to one embodiment of the present invention, the plate 10 also includes a power module 26 in electrical communication with the lights 16, and having: a battery 28 such as a Duracell CR-V3 Ultra M3 Battery, Duracell, Inc., Berkshire Corporate Park, Bethel, Conn. 06801, that provides direct current (DC) power to the plate 10 and a power cord 30 as coupled to a multitude of electronic devices as one skilled in the art would appreciate. The power cord is removably coupleable to an electrical outlet 31, as indicated by arrow 34, providing alternating current (AC) power to the plate 10, in lieu of the battery source. Conversely, a user may use the battery as a DC source to emit colorful lights in a given room, especially during occasions where AC electrical power line are inoperative and/or when traveling or residing in structures where no electrical outlets 31 are unavailable. In alternative embodiments, many types of batteries 28 may be used to provide DC power to the plate, such as: 1.5-volt batteries, 3-volt batteries, 9-volt batteries, etc.

In another embodiment of the present invention, there is a decorative layer 26 such as the Oakland Raiders National Football League team emblem coupled to the top surface 14 of the circular planar member 12 and is configured to enhance the décor and appearance of the plate 10. Other embodiments of the plate 10 may include a wide variety of decorative layers 26 disposed on its top surface 14 that are suitable to a user's preference. Non-limiting examples of such decorative layers 26 include, but is not limited to: Santas, articles of sports, landscaping, flowers, etc.

In yet another embodiment of the present invention shown in Figure, the light emitting plate 10 has a portion of its top surface 14 cutaway revealing a cylindrical cavity 28 having a low aspect ratio (small depth as compared to width) a through the top surface 16 of the circular planar member 12. The cavity 28 is designed to receive lights 16 so as to provide lighting to the decorative layer 26 coupled to the surface 14, thereby enhancing the image of the layer, as shown in FIG. 2. In addition, the low aspect ratio of the planar member 12 and cavity 28 enabling the plate to be safe to use, difficult to be knocked off of a table or other surface, have more surface area to couple the decorative layer thereon, etc.

In operation of the illustrated embodiment, a user may either choose use the battery 27 or plug the electrical cord 30 into the outlet 31 to provide electrical power to the light emitting plate 10 so as to activate the light sensor module 22 to sense light in the surrounding area. According to one embodiment, once the plate is activated and the light sensor 22 senses insufficient light in a given area, such as during hours of darkness, the sensor will inherently instruct the control module 18 to complete an electrical circuit, thereby inducing the lights 16 to turn “On” in either a stationary or blinking manner, according to a user-selected activation status 20. The user may manipulate the control module 18 change intensity statuses 16, 23 of the lights according to his or her preference. The range of light intensity statuses 16, 23 controlled by the control module 18 may vary according to various embodiments of the invention. The user may employ the plate 10 as: a serving plate for food items, a decorative display on a wall 36, table or other surface; as a night light to facilitate safety during hours of darkness; as an ornament during various holidays, etc.

In operation of the illustrated embodiment, whenever the light sensor 22 senses sufficient light in a given area where the plate is employed, the light sensor will cease any transmission of an electromagnetic signal to the control module 18. As a result, control module 18 will break the electrical circuit, regardless of light intensity statuses 16, 23 and the lights 16 will longer be emitted from the plate 10.

Embodiments of the light emitting plate 10 fulfill the need for an ornate means to provide illumination that would also enhance the décor and appearance within various rooms throughout a building structure. In addition, the plate 10 acts as a ornate illuminated decorative device to provide safety to users during hours of darkness or in dark areas.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Although FIGS. 1 and 2 illustrate the plate 10 being circular in shape, one skilled in the art would appreciate that the plate may be shaped differently, depending on an embodiment of the invention.

Additionally, although the FIGS. 1 and 2 illustrate the power cord 30 having a two-pronged plug 25 coupleable to the outlet 31 having two apertures 27, it is one skilled in the art would know the plate 10 may be constructed to include a three-pronged power cord coupleable to an electrical outlet having three apertures 29.

It is also envisioned that the number and/or arrangement of lights 16 disposed in the circular planar member 12 may vary according to various embodiments. For example, circular planar member 12 may include 10 lights, 15 lights, 17 lights, etc. In addition, the arrangement of lights 16 may be symmetrical or asymmetrical.

It is further envisioned that the power module 24; decorative layer 26; battery 27; power cord 30 may be coupled to, and disposed anywhere on the plate 10, wherein the present invention functions according to its intended purpose.

It is expected that there could be numerous variations of the design of this invention. An example is that the circular planar member 12; top 14; lights 16; control module; light sensor module 22; power module 24; power cord 25; decorative layer 26; battery 27; cavity 28; and/or power cord 30 may vary in length, width, size, shape, design, color, thickness, diameter, depth, etc., according to various embodiments.

Finally, it is envisioned that the components of the device may be constructed of a variety of materials, such as ceramic, metal, glass, stained glass, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A light emitting plate, comprising:
a) a circular planar member, being cylindrical and having a low aspect ratio, having a top surface;
b) a plurality of light emitting devices disposed within the circular planar member and visible through the top surface;
c) a control module in communication with the plurality of light emitting devices and configured to control an activation status of the plurality of light emitting devices;
d) a light sensor module coupled to the circular planar member and in communication with the control module, wherein the light sensor module provides a signal to the control module, wherein the signal is indicative of a light level;
e) a power module in communication with the plurality of light emitting devices; and configured to provide power to the light emitting devices.
f) a decorative layer coupled to the top surface of the circular planar member and configured to provide a decoration thereon.

2. The light emitting plate of claim 1, wherein the power module comprises a battery.

3. The light emitting plate of claim 1, wherein the power module comprises a power cord removably coupleable to an electrical outlet.

4. The light emitting plate of claim 1, wherein the circular planar member includes a cylindrical cavity with a low aspect ratio through the top surface.

5. A light emitting plate, consisting essentially of:
a) a circular planar member, being cylindrical and having a low aspect ratio, having a top surface;
b) a plurality of light emitting devices disposed within the circular planar member and visible through the top surface;
c) a control module in communication with the plurality of light emitting devices and configured to control an activation status of the plurality of light emitting devices;
d) a light sensor module coupled to the circular planar member and in communication with the control module, wherein the light sensor module provides a signal to the control module, wherein the signal is indicative of a light level;
e) a power module in communication with the plurality of light emitting devices; and configured to provide power to the light emitting devices.
f) a decorative layer coupled to the top surface of the circular planar member and configured to provide a decoration thereon.

6. The light emitting plate of claim 5, wherein the power module comprises a battery.

7. The light emitting plate of claim 5, wherein the power module comprises a power cord removably coupleable to an electrical outlet.

8. The light emitting plate of claim 6, wherein the circular planar member includes a cylindrical cavity with a low aspect ratio through the top surface.
